(19) United States
(12) Patent Application Publication
(10) Pub. No.: US 2026/0310571 A1
(43) Pub. Date: Oct. 8, 2026

(54) OPTIMIZING COST AND PERFORMANCE IN DISTRIBUTED SYSTEMS

(71) Applicant: Dell Products L.P., Round Rock, TX (US)

(72) Inventors: ZIJIA WANG, London (GB); XIAOCHEN CHEN, Shanghai (CN); SCOTT E. JOYCE, Foxboro, MA (US); NING LI, Shanghai (CN)

(21) Appl. No.: 19/098,560

(22) Filed: Apr. 2, 2025

(51) Int. Cl. G06F 11/34; G06F 9/50

(52) U.S. Cl. CPC G06F 11/3409; G06F 9/5027

(57) ABSTRACT

Methods and systems for managing performance of workloads in a distributed system are disclosed. The performance may be managed by determining the performance of the workloads through updating, using at least stakeholder feedback, synthetic feedback, and/or costs of the workloads, a decision model. The costs may be compared to a cost threshold. Based on the comparison, stakeholder feedback and/or synthetic feedback, from the decision model, may be used to generate at least one scaling factor. The at least one scaling factor and/or the costs may be used to generate rewards. The rewards may be ingested by the decision model to update the decision model. With each update, the decision model may be trained to select, for performance, workloads that do not exceed the cost threshold.

### FIELD

Embodiments disclosed herein relate generally to managing performance of workloads in a distributed system. More particularly, embodiments disclosed herein relate to determining the performance of the workloads through updating, using at least stakeholder feedback, synthetic feedback, and/or costs of the workloads, a decision model.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2B show data flow diagrams illustrating operation of the distributed system in accordance with an embodiment.

FIGS. 3A-3B show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing performance of workloads in a distributed system. The performance may be managed by determining the performance of the workloads through updating, using at least stakeholder feedback, synthetic feedback, and/or costs of the workloads, a decision model.

The performance of the workloads may be determined first by computing a cost of a workload. The cost may be computed by determining at least one requirement of servicing a workload request to perform a workload of the workloads. The cost may include (i) CPU/GPU usage, (ii) memory usage, (iii) network bandwidth, (iv) energy consumption, (v) resource allocation efficiency, (vi) financial costs of using at least one at least one hardware component and/or at least one software component of a management system and/or any number of data processing systems of the distributed system, (vii) input/output operations, etc.

The cost may be compared to a cost threshold. If the cost (i) matches and/or (ii) is below a cost threshold, then (i) the workload request may be serviced and/or (ii) feedback may be collected from (i) a stakeholder and/or (ii) the decision model. Otherwise, if the cost exceeds the cost threshold, then the feedback may be collected from (i) the stakeholder and/or (ii) the decision model.

Feedback may be collected from the stakeholder. The feedback may include (i) an acceptance and/or a rejection of a result of the cost comparison, (ii) a stakeholder decision to service the workload request, and/or (iii) any other feedback from the stakeholder. Using the feedback, at least one first scaling factor may be used with the cost to generate a reward. The reward may be used to update the decision model. By updating the decision model, the decision model may be trained to service workload requests that meet and/or are below the cost threshold.

If a stakeholder does not provide the feedback, synthetic feedback may be collected from the decision model. The synthetic feedback of the decision model may include (i) at least one second scaling factor that is determined using at least one first attribute of a submitter and/or at least one second attribute the distributed system. The at least one first attribute and/or the at least one second attribute may be determined based on (i) frequent high-cost workload requests by a submitter, (ii) workload requests that include use times during which a significant portion of computational resources of the distributed system is unavailable, (iii) any other attribute of the submitter and/or the distributed system in regard to the cost of servicing the workload request. Using the synthetic feedback of the decision model, at least one second scaling factor may be used with the cost to generate the reward. The reward may be used to update the decision model. By updating the decision model, the decision model may be trained to service workload requests that meet and/or are below the cost threshold.

In an embodiment, a method for managing performance of workloads in a distributed system is disclosed. The method may include: (i) obtaining a workload request for performance of a workload by the distributed system, (ii) based on obtaining the workload: (a) obtaining a first representation of a state of the distributed system, (b) obtaining a second representation of the state of a submitter of the workload request, (c) obtaining, using a decision model, a performance decision for the workload request based on at least the first representation and the second representation, (d) initiating performance of the workload by the distributed system, in an instance where the performance decision is to service the workload request, (e) obtaining feedback regarding desirability of the performance decision using at least the performance decision and a basis for the performance decision, and (f) updating the decision model based on the feedback to obtain an updated decision model for use in management of future workload requests.

The first representation of the state of the distributed system may include at least one system metric of the distributed system, the at least one system metric indicating a workload efficiency and availability of the distributed system.

The first representation may include a first one selected from a first group consisting of (i) central processing unit/graphical processing unit cores, (ii) memory usage, and (iii) network congestion.

The second representation of the state of the submitter of the workload request may include at least one user metric of the submitter of the distributed system, the at least one user metric indicating performance metrics and usage metrics.

The second representation may include a second one selected from a second group consisting of (i) past query costs, (ii) acceptance/rejection rates, and (iii) average complexity of queries.

The decision model may include a trained machine learning model that ingests at least the first representation and at least the second representation.

The decision model may further include an action space, the action space comprising at least one modification to a configuration of the workload of the workload request.

The configuration may include at least one selected from a group consisting of (i) allocated computational resources, (ii) limits of the allocated computational resources, (iii) workload energy consumption constraints, and (iv) workload scheduling constraints.

The performance decision may determine whether to service, by the distributed system, the workload request.

The basis for the performance decision may include a cost score, determined by the decision model, to the distributed system to service the workload request.

The feedback may include at least one scaling factor that is applied to the cost score.

The at least one scaling factor may be generated by the decision model using the first representation of the state of the distributed system and the second representation of the state of the distributed system.

The at least one scaling factor may be generated using synthetic user feedback that is derived from historical user feedback.

The at least one scaling factor may be generated by a stakeholder of the decision model.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

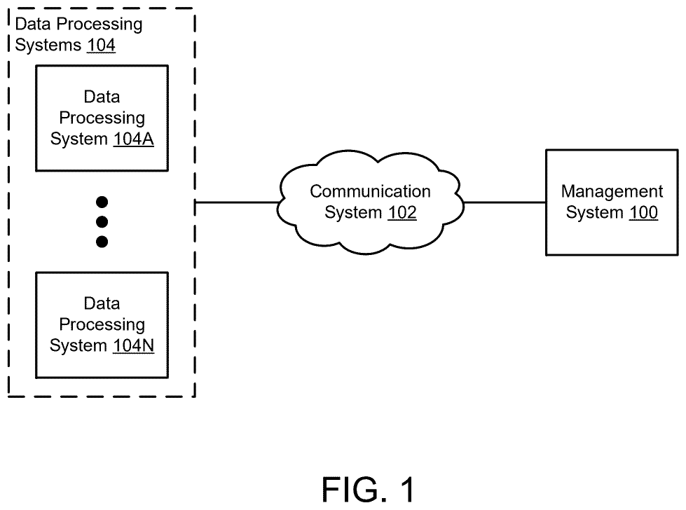

Turning to FIG. 1, a distributed system in accordance with an embodiment is shown. The distributed system may provide any number and types of computer implemented services (e.g., to user of the system and/or devices operably connected to the system). The computer implemented services may include, for example, data storage service, instant messaging services, etc.

To provide the computer implemented services, the distributed system may perform at least one workload. The at least one workload may include (i) data processing (e.g., performing an analysis of customer purchase data to identify trends, etc.), (ii) database operations (e.g., managing user profiles and activity logs for a social media application, etc.), (iii) network services (e.g., distributing incoming traffic to at least one other server to ensure high availability, etc.), etc.

The distributed system may receive the at least one workload from at least one user of the distributed system. Further, performance of the at least one workload may include allocation of at least a significant measure of computational resources (e.g., central processing unit (CPU) usage, graphical processing unit (GPU) usage, memory usage, etc.). As a result, the performance of the at least one workload may be constrained by the computational resources available to the distributed system. Therefore, the computer implemented services may be impacted.

In general, embodiments disclosed here relate to systems and methods for managing performance of workloads in a distributed system. The performance of the workloads may be managed by (i) obtaining a workload request for performance of a workload by the distributed system, (ii) obtaining a first representation of a state of the distributed system, (iii) obtaining a second representation of a state of a submitter of the workload request, (iv) obtaining, using a decision model, a performance decision for the workload request based on at least the first representation and the second representation, (v) initiating performance of the workload by the distributed system, in an instance where the performance decision is to service the workload request, (vi) obtaining feedback regarding desirability of the performance decision using at least the performance decision and/or a basis for the performance decision, and/or (vii) updating the decision model based on the feedback to obtain an updated decision model for use in management of future workload requests.

The workload request for the performance of the workload by the distributed system may be obtained by receiving the workload request. A method of receiving the workload request may include (i) a direct client request (e.g., a client sends the workload directly to the distributed system though (a) an application programming interface, (b) a web-service, (c) an Internet of Things (IoT) device, (d) any other interface method that enables reception of the workload request), (ii) a message queue (e.g., the workload request is placed in a queue and/or is processed by the distributed system in order in which the workload request was placed, etc.), (iii) a user interface (e.g., a user inputs the workload request through a graphical user interface (GUI) and/or a command-line interface (CLI), etc.), etc. The workload request may include (i) a task description (e.g., a definition of the workload to be performed by the distributed system), (ii) a priority level (e.g., an indication of an urgency of the workload, such as “high,” “medium,” and/or “low”), (iii) resource requirements (e.g., at least one computational requirement of the workload, such as CPU/GPU cores, memory, disk space, etc.), etc.

The first representation of a state of the distributed system may be obtained by (i) using monitoring software by the distributed system to extract system metrics (e.g., CPU/GPU usage, memory usage, network activity, etc.), (ii) (a) performing periodic snapshots of the distributed system and/or (b) extracting the system metrics from the periodic snapshots, (iii) (a) performing analyses of system logs of the distributed system, and/or (b) extracting the system metrics from the system logs, and/or (iv) using any other software, process, analysis, etc. to obtain the system metrics from the distributed system. The system metrics may be aggregated to generate the first representation. The first representation may be stored in a first repository.

The second representation of the state of the submitter of the request may be obtained by collecting historical workload metrics for historical workloads requested by the user. The collection may include gathering computational resource usages of the historical workloads requested by the submitter. In addition, acceptance metrics and/or rejection metrics of the historical workloads may be extracted in the collection. Further, any other details of the historical workloads, including and/or not limited to (a) average runtimes, (b) resource requirements, (c) performance times, (d) success rates, may be extracted. Finally, (a) the computational resource usages, (b) the acceptance metrics and/or the rejection metrics, (c) the any other details of the historical workloads may be aggregated to generate the second representation of the state of the submitter of the workload request. The second representation may be stored in a second repository.

The performance decision for the workload request may be obtained, using a decision model, based on at least the first representation and/or at least the second representation. The performance decision may be obtained by determining a cost score of the workload. The cost score may include a quantitative measure (e.g., a first number that is bounded between a low second number and/or a high third number, a percentage score, etc.) that is based on at least one requirement to servicing a workload request by the distributed system. The at least one requirement may include (i) CPU/GPU usage, (ii) memory usage, (iii) network bandwidth, (iv) energy consumption, (v) resource allocation efficiency, (vi) financial costs of using at least one at least one hardware component and/or at least one software component of the distributed system, (vii) input/output operations, etc. The cost score may be determined using a trained machine learning model (e.g., policy gradient models, proximal policy optimization models, actor-critic models, etc.). The trained machine learning model may (i) ingest at least (a) the first representation, (b) the second representation, and/or (c) the workload and/or (ii) generate the cost score to service, by the distributed system, the workload request. Then, the cost score may be compared to a cost threshold of the distributed system. If the cost score (i) is less than and/or (ii) matches the cost threshold, then performance decision may include (i) servicing, by the distributed system, the workload request and/or (ii) obtaining the feedback regarding the desirability of the performance decision. Otherwise, if the cost score exceeds the cost threshold, then performance decision may include obtaining the feedback regarding the desirability of the performance decision.

In the instance where the performance decision is to service the workload request, the performance of the workload may be initiated by the distributed system. The performance may be initiated by (i) assigning the workload to at least one available data processing system, (ii) allocating, by, for example, a management system of the distributed system, computational resources to the at least one available data processing system based on resource availability and/or priority, (iii) distributing any input data to the at least one available data processing system for performing the workload, (v) performing, by the at least one available data processing system, the workload using the allocated computational resources and/or the any input data, (vi) collecting, by a second data processing system, output generated by the at least one available data processing system from performing the workload, (vii) transmitting, by the second data processing system, the output to the submitter of the workload, (viii) deallocating, by, for example, the management system of the distributed system, the allocated computational resources, etc.

The feedback regarding the desirability of the performance decision may be obtained by generating a reward using at least the performance decision and/or a basis for the performance decision. The basis for the performance decision may include the cost score. The reward may be generated by either (i) the decision model and/or (ii) a stakeholder (e.g., (a) an administrator, (b) an operator, (c) a specialist, and/or (d) any other stakeholder) of the distributed system. During generation of the reward, at least one first scaling factor (e.g., a positive number and/or a negative number, etc.), the cost score, and/or the cost threshold may be ingested in a mathematical expression to generate the reward. If the decision model generates the reward, at least one second scaling factor generated using at least one system metric of the first representation and/or at least one third scaling factor generated using at least one submitter metric of the second representation may also be ingested by the mathematical expression to generate the reward.

Finally, the decision model may be updated to obtain the updated decision model. The decision model may be updated by using at least the reward to update at least one parameter (e.g., a weight, a bias, a gradient, etc.) of the decision model to generate at least one updated decision model. The decision model may then continue to be updated by ingesting (i) another workload request, (ii) another first representation, and/or (iii) another second representation to generate another reward. The decision model may be repeatedly updated until the decision model consistently generates cost scores that (i) match and/or (ii) are less than the cost threshold. By consistently generating the cost scores that (i) match and/or (ii) are less than the cost threshold, the decision model may manage at least one workload submitted by at least one submitter of the distributed system. As a result, computer implemented services may be provided by the distributed system.

To provide the above noted functionality, the system may include management system 100, and data processing systems 104. Each of these components is discussed below.

Management system 100 and/or any number of data processing systems 104 may obtain a workload request for performance of a workload. The workload request may be transmitted from a client data processing system (e.g., any number of data processing systems 104) to either management system 100 and/or the any number of data processing systems 104.

The first representation of a state of the distributed system may be obtained from any component of management system 100 and/or the any number of data processing systems 104. The first representation may include at least one system metric (e.g., CPU/GPU usage, memory usage, network activity, etc.) from (i) monitoring software, (ii) a periodic snapshot, (iii) a system log, and/or (iv) any other data structure that includes the at least one system metric. The first representation may be transmitted to management system 100 and/or the any number of data processing systems 104.

The second representation of a state of a submitter may be obtained from any component of management system 100 and/or the any number of data processing systems 104. The second representation may include an aggregation of (a) computational resource usages, (b) acceptance metrics and/or rejection metrics, and/or (c) the any other details of the historical workloads submitted by a submitter. The second representation may be transmitted to management system 100 and/or any number of data processing systems 104.

The decision model may be stored and/or used by management system 100 and/or any number of data processing systems 104 to generate a cost score associated with servicing the workload request. The decision model may include a trained machine learning model (e.g., policy gradient models, proximal policy optimization models, actor-critic models, etc.). The cost score may include a quantitative measure (e.g., a first number that is bounded between a low second number and/or a high third number, a percentage score, etc.) that is based on at least one requirement to servicing a workload request by the any number of data processing systems 104. The at least one requirement may include (i) CPU/GPU usage, (ii) memory usage, (iii) network bandwidth, (iv) energy consumption, (v) resource allocation efficiency, (vi) financial costs of using at least one at least one hardware component and/or at least one software component of management system 100 and/or any number of data processing systems 104, (vii) input/output operations, etc.

Management system 100 and/or the any number of data processing systems 104 may use the decision model to generate the performance decision. To generate the performance decision, management system 100 and/or any number of data processing systems 104 may perform a comparison between the cost score and/or a cost threshold of the distributed system. If the cost score (i) is less than and/or (ii) matches the cost threshold, then performance decision may include (i) servicing the workload request by performing, by the any number of data processing systems 104, the workload and/or (ii) obtaining the feedback regarding the desirability of the performance decision.

Management system 100 and/or the any number of data processing systems 104 may obtain the feedback by generating a reward using at least the performance decision a basis for the performance decision. The performance decision may be obtained by generating, by management system 100 and/or any number of data processing systems 104, a reward using at least the performance decision and/or the basis for the performance decision. The basis for the performance decision may include the cost score. The reward may be generated by either (i) the decision model and/or (ii) a stakeholder ((a) an administrator, (b) an operator, (c) a specialist, and/or (d) any other stakeholder) of the distributed system.

Finally, management system 100 and/or the any number of data processing systems 104 may update the decision model to obtain the updated decision model. Management system 100 and/or the any number of data processing systems 104 may update the decision model by using at least the reward to update at least one parameter (e.g., a weight, a bias, a gradient, etc.) of the decision model to generate at the updated decision model.

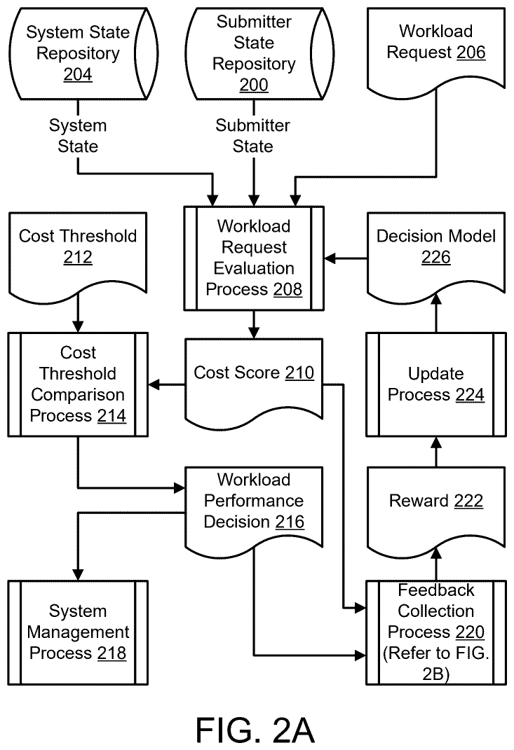

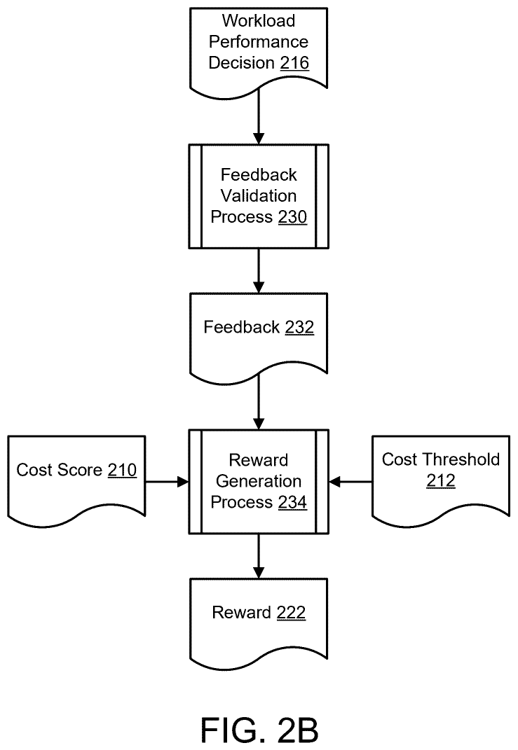

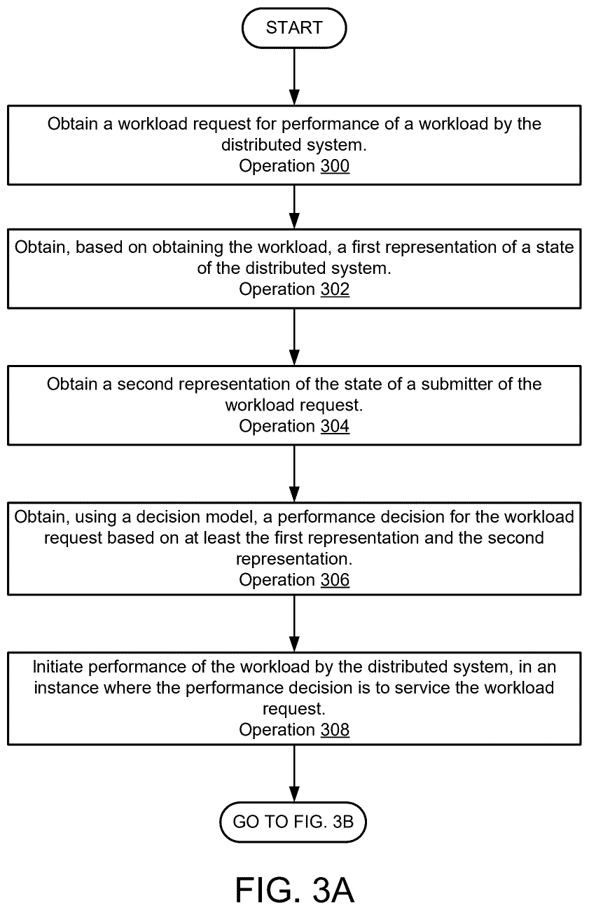

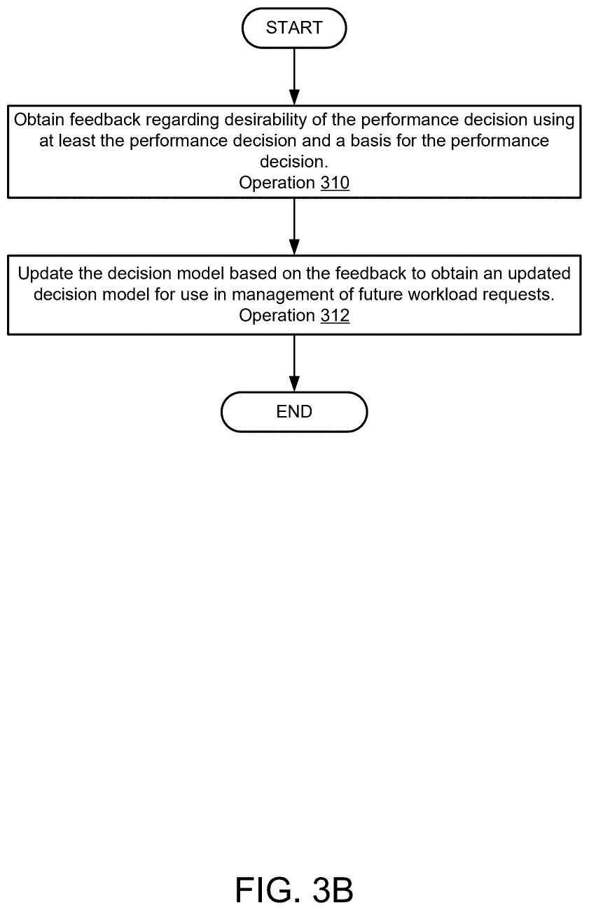

While providing their functionality, any of management system 100 and data processing systems 104 may perform all, or a portion, of the flows and methods shown in FIGS. 2A-3B.

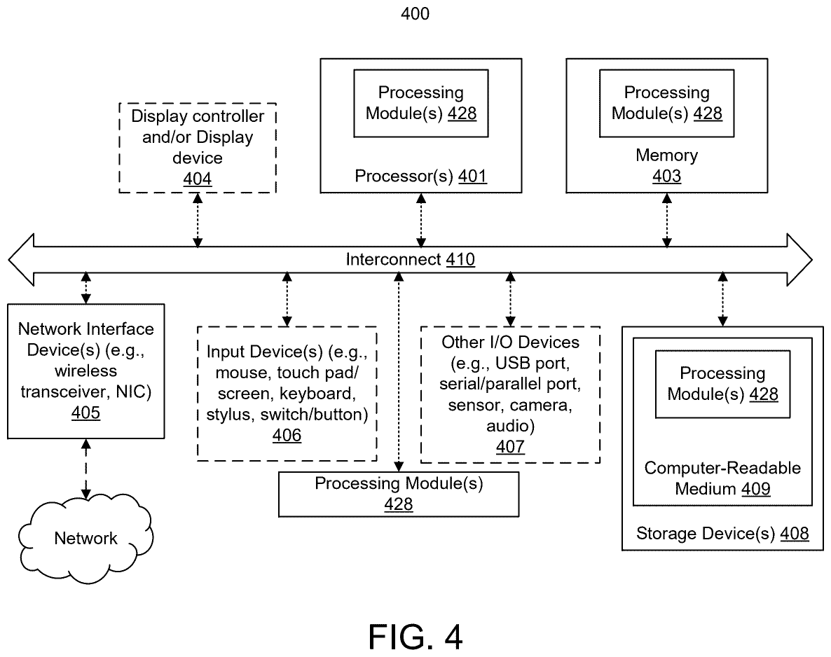

Any of (and/or components thereof) management system 100 and data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 206, 212, etc.) is used to represent data structures, a second set of shapes (e.g., 208, 214, etc.) is used to represent processes performed using and/or that generate data, and a third set of shapes (e.g., 200, 204, etc.) is used to represent large scale data structures such as databases.

Turning to FIG. 2A, a first data flow diagram in accordance with an embodiment is shown. The first data flow diagram may illustrate data used in and data processing performed in performing an update (e.g., 224) to a trained model (e.g., 226).

To perform the update (e.g., 224) to the trained model (e.g., 226), a workload request evaluation process (e.g., 208) may be performed. During the workload request evaluation process (e.g., 208), (i) a workload request (e.g., 206), (ii) a system state, and/or (iii) a submitter state may be ingested by the workload request evaluation process (e.g., 208).

During the workload request evaluation process (e.g., 208), the workload request may be received. A method of receiving the workload request may include (i) a direct client request (e.g., a client sends the workload directly to the distributed system though (a) an application programming interface, (b) a web-service, (c) an Internet of Things (IoT) device, (d) any other interface method that enables reception of the workload request (e.g., 206)), (ii) a message queue (e.g., the workload request is placed in a queue and/or is processed by the distributed system in order in which the workload request was placed), (iii) a user interface (e.g., a user inputs the workload request through a graphical user interface (GUI) and/or a command-line interface (CLI)), etc. The workload request may include (i) a task description (e.g., a definition of a workload to be performed by the distributed system), (ii) a priority level (e.g., an indication of an urgency of the workload, such as “high,” “medium,” and/or “low”), (iii) resource requirements (e.g., at least one computational requirement of the workload, such as CPU/GPU cores, memory, disk space, etc.), etc. The workload of the workload request may include (i) big data analysis (e.g., analyzing customer behavior to improve market strategies, etc.), (ii) machine learning training (e.g., training machine learning models to perform, for example, image recognition, etc.), (iii) scientific simulations (e.g., simulating climate models to predict weather patterns, etc.), etc.

During the workload request evaluation process (e.g., 208), the submitter state may be obtained. The submitter state may be obtained from a submitter state repository (e.g., 200). The submitter state may include a collection of historical workload metrics for historical workloads requested by the submitter of the workload request (e.g., 206). The collection may be generated by collecting computational resource usages of the historical workloads requested by the submitter. In addition, acceptance metrics and/or rejection metrics of the historical workloads may be extracted in the collection. Further, any other details of the historical workloads, including (a) average runtimes, (b) resource requirements, (c) performance times, (d) success rates, etc. of the historical workloads, may be extracted. Finally, (a) the computational resource usages, (b) the acceptance metrics and/or the rejection metrics, (c) the any other details of the historical workloads may be aggregated to create the second representation of the state of the submitter of the workload request.

During the workload request evaluation process (e.g., 208), the system state may be obtained. The system state may be obtained from a system state repository (e.g., 204). Before storage of the system state in the system state repository (e.g., 204), the system state may be generated using (i) monitoring software by the distributed system to extract system metrics (e.g., CPU/GPU usage, memory usage, network activity, etc.), (ii) performing periodic snapshots of the distributed system and/or extracting the system metrics from the periodic snapshots, (iii) performing analyses of system logs of the distributed system and/or extracting the system metrics from the system logs, and/or (iv) using any other software, process, analysis, etc. to obtain the system metrics from the distributed system.

Once the workload request (e.g., 206), the submitter state, and/or the system state have been obtained, the workload request evaluation process (e.g., 208) may be continued. During the workload request evaluation process (e.g., 207), the workload request (e.g., 206), the submitter state, and/or the system state may be ingested to generate, by a decision model (e.g., 226), a cost score (e.g., 210). The decision model (e.g., 226) may include a trained machine learning model (e.g., policy gradient models, proximal policy optimization models, actor-critic models, etc.).

The decision model (e.g., 226) may generate the cost score (e.g., 210) by (i) performing a feature extraction, (ii) generating an environment representation that includes features from the feature extraction, (iii) evaluating, using the decision model and/or the environment representation, possible configuration changes in the workload of the workload request and/or (iv) generating the cost score (e.g., 210) based on the possible configuration changes.

The features of the workload request may be extracted by obtaining, from the workload request (e.g., 206), (i) the task description (e.g., a definition of a workload to be performed by the distributed system), (ii) the priority level (e.g., an indication of an urgency of the workload, such as “high,” “medium,” and/or “low”), (iii) the resource requirements (e.g., at least one computational requirement of the workload, such as CPU/GPU cores, memory, disk space, etc.), (d) any other attributes of the workload included in the workload request. The features of the system state may be extracted by obtaining, from the system state, the system metrics (e.g., CPU/GPU usage, memory usage, network activity, etc.). The features of the submitter state may be extracted by obtaining, from the submitter state, (a) the computational resource usages, (b) the acceptance metrics and/or rejection metrics, and/or (c) the any other details of the historical workloads.

The environment representation may be generated by aggregating the features from the feature extraction. The environment representation may be aggregated in, for example, an n-dimensional data structure (e.g., an array, a matrix, a tensor, and/or any other uni-/multi-dimensional array) that includes at least one metric from at least (i) the workload request (e.g., 206), (ii) the system state, and/or (iii) the submitter state.

The possible configuration changes in the workload may be evaluated, using the decision model and/or the environment representation, by generating the possible configuration changes in the environmental representation using an action space of the decision model. The action space may include (i) variations of allocated computational resources, (ii) the variations on limits of the allocated computational resources, (iii) workload energy consumption constraints, (iv) workload scheduling constraints, etc.

The possible configuration changes may be evaluated, using the decision model and/or the environment representation. The possible configuration changes may be evaluated by computing a cost score difference as a result of at least one of the possible configuration changes. The cost score difference may include a quantitative measure (e.g., a positive and/or negative number, etc.) that is based on at least one cost score difference between an initial cost score (e.g., a cost score of the workload that does not include a possible configuration change) and/or a final cost score (e.g., a cost score of the workload that includes the possible configuration change). The possible configuration change may include a change in (i) CPU/GPU usage, (ii) memory usage, (iii) network bandwidth, (iv) energy consumption, (v) resource allocation efficiency, (vi) financial costs of using at least one at least one hardware component and/or at least one software component of the distributed system, (vii) input/output operations, etc.

Finally, the cost score (e.g., 210) as a result of the possible configuration changes. The cost score (e.g., 210) may be generated by combining the initial cost score and/or a sum of the at least one cost score difference. The cost score (e.g., 210) may include a quantitative measure (e.g., a first number that is bounded between a low second number and/or a high third number, a percentage score, etc.) that is based on at least one of the possible configuration changes.

The cost score (e.g., 210) and/or a cost threshold (e.g., 212) may be ingested by a cost threshold comparison process (e.g., 214). The cost threshold (e.g., 212) may include a maximum acceptable cost for servicing a workload request. The cost threshold (e.g., 212) may be generated based on (i) historical workload costs, (ii) available computational resources of the distributed system, (iii) at least one policy of the distributed system, etc.

During cost threshold comparison process (e.g., 214), a comparison between the cost score (e.g., 210) and/or a cost threshold (e.g., 212) may be performed. From cost threshold comparison process (e.g., 214), a workload performance decision (e.g., 216) may be generated. If the cost score (e.g., 210) (i) is less than and/or (ii) matches the cost threshold (e.g., 212), then the workload performance decision (e.g., 216) may include (i) performing a system management process (e.g., 218) and/or (ii) performing a feedback collection process (e.g., 220). Otherwise, if the cost score (e.g., 210) exceeds the cost threshold (e.g., 212), then performance decision may include performing the feedback collection process (e.g., 220).

During the system management process (e.g., 218), the workload request may be serviced. The servicing of the workload request may include by (i) assigning the workload to at least one available data processing system, (ii) allocating, by, for example, a management system (e.g., 100) of the distributed system, computational resources to the at least one available data processing system based on resource availability and/or priority, (iii) distributing any input data to the at least one available data processing system for performing the workload, (v) performing, by the at least one available data processing system, the workload using the allocated computational resources and/or the any input data, (vi) collecting, by a second data processing system, output generated by the at least one available data processing system from performing the workload, (vii) transmitting, by the second data processing system, the output to the submitter of the workload, (viii) deallocating, by, for example, the management system (e.g., 100) of the distributed system, the allocated computational resources, etc.

During the feedback collection process (e.g., 220), the cost score (e.g., 210) may be used to generate a reward (e.g., 222). The feedback collection process (e.g., 220) is described in the description of FIG. 2B.

The reward (e.g., 222) may be a numerical value that reflects an outcome of the cost threshold comparison process (e.g., 214). The numerical value may include a positive and/or negative value. A magnitude and/or a sign (e.g., positive, negative, etc.) of the reward (e.g., 222) may serve to provide positive reinforcement (e.g., to encourage servicing of workload requests that have cost scores (e.g., 210) matching and/or below the cost threshold (e.g., 212)) and/or negative reinforcement (e.g., to discourage servicing of workload requests that have cost scores (e.g., 210) exceeding the cost threshold (e.g., 212)).

The reward (e.g., 222) may be ingested by an update process (e.g., 224). During update process (e.g., 224), the decision model (e.g., 226) may ingest the reward (e.g., 222) associated with servicing the workload request (e.g., 206). To maximize obtaining future rewards, the decision model (e.g., 226) may update at least one parameter (e.g., a weight, a bias, a gradient, etc.) of the decision model (e.g., 226). As a result, in a future performance of the workload request evaluation process (e.g., 208), the decision model (e.g., 226) may perform a second at least one possible configuration change to a second workload request (e.g., 206, etc.). The at least one possible configuration change may result, using the second workload request (e.g., 206, etc.), in generation of a second cost score (e.g., 210, etc.). The second cost score (e.g., 210, etc.) may be more likely to (i) match and/or (ii) be below a second cost threshold (e.g., 212, etc.).

Thus, via the first data flow diagram illustrated in FIG. 2A, a system in accordance with an embodiment may perform the update (e.g., 224) to the decision model (e.g., 226). Consequently, the distributed system may be more likely to be able to provide desired computer implemented services by increasing a likelihood of making at least one configuration change, by the decision model (e.g., 226), to a workload request that is computed to have the cost score (e.g., 210) that matches and/or is below the cost threshold (e.g., 212).

Turning to FIG. 2B, a second data flow diagram in accordance with an embodiment is shown. The second data flow diagram may illustrate data used in and data processing performed in generating a reward (e.g., 222) for performance of an update (e.g., 224) to a decision model (e.g., 226).

To generating the reward (e.g., 222), a feedback validation process (e.g., 230) may be performed. During the feedback validation process (e.g., 230), feedback (e.g., 232) may be generated. To generate the feedback (e.g., 232), a workload performance decision (e.g., 216) may first be ingested by the decision model (e.g., 226). Also, a stakeholder (e.g., (i) an administrator, (ii) an operator, (iii) a specialist, and/or (iv) any other stakeholder) of the distributed system may contribute to generation of the feedback (e.g., 232). If the stakeholder is not available to provide the feedback (e.g., 232), then the decision model (e.g., 226) may contribute to generation of the feedback (e.g., 232).

If the stakeholder is available, then the stakeholder may contribute to generation of the feedback (e.g., 232). A first contribution by the any other may include (i) a declaration of acceptance and/or rejection of (a) servicing the workload request, (b) a value of the cost score (e.g., 210), and/or (c) any first value and/or any first determination generated by the decision model (e.g., 226).

However, if the stakeholder is not available, then the decision model (e.g., 226) may contribute to generation of the feedback (e.g., 232). A second contribution by the decision model (e.g., 226) may include any second value generated by the decision model (e.g., 226). The any second value may be determined based on (i) frequent high-cost workload requests by a submitter, (ii) workload requests that include use times during which a significant portion of computational resources of the distributed system is unavailable, (iii) any other attribute of the submitter and/or the distributed system in regard to a cost of servicing the workload requests.

The feedback (e.g., 232), a cost score (e.g., 210, from the description of FIG. 2A), and/or a cost threshold (e.g., 212, from the description of FIG. 2A) may be ingested in a reward generation process (e.g., 234). During the reward generation process (e.g., 234), the reward (e.g., 222) may be computed using the feedback (e.g., 232, generated by the stakeholder and/or the decision model (e.g., 226)), the cost score (e.g., 210), and/or the cost threshold (e.g., 212). The reward (e.g., 222, described the description of FIG. 2A) may be computed by inputting at least a portion of the feedback (e.g., 232), at least the cost score (e.g., 210), and/or at least the cost threshold (e.g., 212) into a mathematical expression to generate, using the mathematical expression, the reward (e.g., 222).

Thus, via the second data flow diagram illustrated in FIG. 2B, a system in accordance with an embodiment may generate the reward (e.g., 222) for the performance of the update (e.g., 224) to the decision model (e.g., 226). Consequently, the distributed system may be more likely to be able to provide desired computer implemented services by generating, by the stakeholder and/or the decision model (e.g., 226), the reward (e.g., 222).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to managing performance of workloads in a distributed system. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIGS. 3A-3B, a flow diagram illustrating a method of managing the performance of the workloads in the distributed system in accordance with an embodiment is shown. The method may be performed, for example, by any of the components of the system of FIG. 1, and/or other components not shown therein.

At operation 300, a workload request may be obtained for performance of a workload by the distributed system. The workload request may be obtained by receiving the workload request. A method of receiving the workload request may include (i) a direct client request (e.g., a client sends the workload directly to the distributed system though (a) an application programming interface, (b) a web-service, (c) an Internet of Things (IoT) device, (d) any other interface method that enables direct transmission of the client request), (ii) a message queue (e.g., the workload request is placed in a queue and/or is processed by the distributed system in order in which the workload request was placed), (iii) a user interface (e.g., a user inputs the workload request through a graphical user interface (GUI) and/or a command-line interface (CLI)), etc.

At operation 302, based on obtaining the workload, a first representation of the state of the distributed system may be obtained. The first representation may be obtained by (i) using monitoring software by the distributed system to extract system metrics (e.g., CPU/GPU usage, memory usage, network activity, etc.), (ii) performing periodic snapshots of the distributed system and/or extracting the system metrics from the periodic snapshots, (iii) performing analyses of system logs of the distributed system, and/or extracting the system metrics from the system logs, and/or (iv) using any other software, process, analysis, etc. to obtain the system metrics (e.g., CPU/GPU usage, memory usage, network activity, etc.) from the distributed system. The system metrics (e.g., CPU/GPU usage, memory usage, network activity, etc.) may be aggregated to generate the first representation. The first representation may be stored in a first repository.

At operation 304, based on obtaining the workload, a second representation of the state of a submitter of the workload request may be obtained. The second representation may be obtained by collecting historical workload metrics for historical workloads requested by the user. The collection may include gathering computational resource usages of the historical workloads requested by the submitter. In addition, a first number of acceptance metrics and/or a second number of rejection metrics of the historical workloads may be extracted in the collection. Further, any other details of the historical workloads, including (a) average runtimes, (b) resource requirements, (c) performance times, (d) success rates, etc. of the historical workloads, may be extracted. Finally, (a) the computational resource usages, (b) the acceptance metrics and/or rejection metrics, and/or (c) the any other details of the historical workloads may be aggregated to generate the second representation of the state of the submitter of the workload request. The second representation may be stored in a second repository.

At operation 306, a performance decision for the workload request based on at least the first representation and the second representation may be obtained using a decision model. The performance decision may be obtained by determining a cost score of the workload. The cost score may include a quantitative measure (e.g., a first number that is bounded between a low second number and/or a high third number, a percentage score, etc.) that is based on at least one requirement to servicing a workload request by the distributed system. The at least one requirement may include (i) CPU/GPU usage, (ii) memory usage, (iii) network bandwidth, (iv) energy consumption, (v) resource allocation efficiency, (vi) financial costs of using at least one at least one hardware component and/or at least one software component of the distributed system, (vii) input/output operations, etc.

At operation 308, performance of the workload may be initiated in an instance where the performance decision is to service the workload request. The performance of the workload may be initiated by (i) assigning the workload to at least one available data processing system, (ii) allocating, by, for example, a management system (e.g., 100) of the distributed system, computational resources to the at least one available data processing system based on resource availability and/or priority, (iii) distributing any input data to the at least one available data processing system for performing the workload, (v) performing, by the at least one available data processing system, the workload using the allocated computational resources and/or the any input data, (vi) collecting, by a second data processing system, output generated by the at least one available data processing system from performing the workload, (vii) transmitting, by the second data processing system, the output to the submitter of the workload, (viii) deallocating, by, for example, the management system (e.g., 100) of the distributed system, the allocated computational resources, etc.

Continuing on FIG. 3B, at operation 310, feedback regarding desirability of the performance decision may be obtained using at least the performance decision and a basis for the performance decision. The feedback may be obtained by generating a reward using at least the performance decision and/or a basis for the performance decision. The basis for the performance decision may include the cost score. The reward may be generated by either (i) the decision model and/or (ii) a stakeholder (e.g., an administrator, an operator, a specialist, and/or any other stakeholder) of the distributed system.

At operation 312, the decision model may be updated based on the feedback to obtain an updated decision model for use in management of future workload requests. The decision model may be updated by using at least the reward to update at least one parameter (e.g., a weight, a bias, a gradient, etc.) of the decision model to generate at least one updated decision model.

The method may end following operation 312.

Thus, via the method shown in FIGS. 3A-3B, embodiments herein may improve a likelihood of managing the performance of the workloads in the distributed system. By improving the likelihood of managing the performance of the workloads in the distributed system, the distributed system may be more likely to provide desirable computer implemented services by, for example, training the decision model to perform at least one configuration change to a workload request, obtaining input, from the stakeholder and/or the decision model, to generate the reward that is used to train the decision model, etc.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing performance of workloads in a distributed system, the method comprising:
obtaining a workload request for performance of a workload by the distributed system;
based on obtaining the workload:
obtaining a first representation of a state of the distributed system;
obtaining a second representation of the state of a submitter of the workload request;
obtaining, using a decision model, a performance decision for the workload request based on at least the first representation and the second representation;
in an instance where the performance decision is to service the workload request:
initiating performance of the workload by the distributed system;
obtaining feedback regarding desirability of the performance decision using at least the performance decision and a basis for the performance decision; and
updating the decision model based on the feedback to obtain an updated decision model for use in management of future workload requests.

2. The method of claim 1, wherein the first representation of the state of the distributed system comprises at least one system metric of the distributed system, the at least one system metric indicating a workload efficiency and availability of the distributed system.

3. The method of claim 2, wherein the first representation comprises a first one selected from a first group consisting of:
central processing unit/graphical processing unit cores;
memory usage; and
network congestion.

4. The method of claim 1, wherein the second representation of the state of the submitter of the workload request comprises at least one user metric of the submitter of the distributed system, the at least one user metric indicating performance metrics and usage metrics.

5. The method of claim 4, wherein the second representation comprises a second one selected from a second group consisting of:
past query costs;
acceptance/rejection rates; and
average complexity of queries.

6. The method of claim 1, wherein the decision model comprises a trained machine learning model that ingests at least the first representation and at least the second representation.

7. The method of claim 6, wherein the decision model further comprises an action space, the action space comprising at least one modification to a configuration of the workload of the workload request.

8. The method of claim 7, wherein the configuration comprises at least one selected from a group consisting of:
allocated computational resources,
limits of the allocated computational resources,
workload energy consumption constraints, and
workload scheduling constraints.

9. The method of claim 1, wherein the performance decision determines whether to service, by the distributed system, the workload request.

10. The method of claim 9, wherein the basis for the performance decision comprises a cost score, determined by the decision model, to the distributed system to service the workload request.

11. The method of claim 10, wherein the feedback comprises at least one scaling factor that is applied to the cost score.

12. The method of claim 11, wherein the at least one scaling factor is generated by the decision model using the first representation of the state of the distributed system and the second representation of the state of the distributed system.

13. The method of claim 12, wherein the at least one scaling factor is generated using synthetic user feedback that is derived from historical user feedback.

14. The method of claim 11, wherein the at least one scaling factor is generated by a stakeholder of the decision model.

15. A non-transitory machine-readable medium having instructions stored therein, which when executed by a processor, cause the processor to perform operations for managing performance of workloads in a distributed system, the operations comprising:
obtaining a workload request for performance of a workload by the distributed system;
based on obtaining the workload:
obtaining a first representation of a state of the distributed system;
obtaining a second representation of the state of a submitter of the workload request;
obtaining, using a decision model, a performance decision for the workload request based on at least the first representation and the second representation;
in an instance where the performance decision is to service the workload request:
initiating performance of the workload by the distributed system;
obtaining feedback regarding desirability of the performance decision using at least the performance decision and a basis for the performance decision; and
updating the decision model based on the feedback to obtain an updated decision model for use in management of future workload requests.

16. The non-transitory machine-readable medium of claim 15, wherein the first representation of the state of the distributed system comprises at least one system metric of the distributed system, the at least one system metric indicating a workload efficiency and availability of the distributed system.

17. The non-transitory machine-readable medium of claim 16, wherein the first representation comprises a first one selected from a first group consisting of:
central processing unit/graphical processing unit cores;
memory usage; and
network congestion.

18. A data processing system, comprising:
a processor; and
a memory coupled to the processor to store instructions, which when executed by the processor, cause the processor to perform operations managing performance of workloads in a distributed system, the operations comprising:
obtaining a workload request for performance of a workload by the distributed system;
based on obtaining the workload:
obtaining a first representation of a state of the distributed system;
obtaining a second representation of the state of a submitter of the workload request;
obtaining, using a decision model, a performance decision for the workload request based on at least the first representation and the second representation;
in an instance where the performance decision is to service the workload request:
initiating performance of the workload by the distributed system;
obtaining feedback regarding desirability of the performance decision using at least the performance decision and a basis for the performance decision; and
updating the decision model based on the feedback to obtain an updated decision model for use in management of future workload requests.

19. The data processing system of claim 18, wherein the first representation of the state of the distributed system comprises at least one system metric of the distributed system, the at least one system metric indicating a workload efficiency and availability of the distributed system.

20. The data processing system of claim 19, wherein the first representation comprises a first one selected from a first group consisting of:
central processing unit/graphical processing unit cores;
memory usage; and
network congestion.
